(19) United States
(12) Patent Application Publication
(10) Pub. No.: US 2021/0230907 A1
(43) Pub. Date: Jul. 29, 2021

(54) DOOR-LOCK DEVICE FOR HOUSEHOLD APPLIANCES AND HOUSEHOLD APPLIANCE COMPRISING SAID DEVICE

(71) Applicant: Bitron S.p.A., Torino (IT)

(72) Inventors: Fabrizio PROMUTICO, Torino (IT); Felice PAGLIA, Torino (IT)

(73) Assignee: Bitron S.p.A., Torino (IT)

(21) Appl. No.: 17/156,661

(22) Filed: Jan. 25, 2021

(30) Foreign Application Priority Data
Jan. 24, 2020 (IT) 102020000001417

(51) Int. Cl. E05B 65/00; D06F 39/14; E05B 47/00

(52) U.S. Cl. CPC E05B 65/00; D06F 39/14; E05B 2047/0017; E05Y 2900/312; E05B 2047/0016; E05B 47/0001

(57) ABSTRACT

The present invention relates to a Door-lock device (1) for a household appliance, such as a washing machine and the like, wherein said household appliance comprises a door provided with a prong (14), comprising a containment casing (10), a holding unit (12), arranged in said containment casing (10), intended to engage with the prong (14) for holding it, a slider (15), contained in a containment casing (10), associated with said holding unit (12), so as to assume a rest position and a working position, when said prong (14) is engaged with said holding unit (12), an electromechanical control module comprising a locking pin (16), capable of assuming a retracted position, in which it disables the power supply of said household appliance, and an extracted position, in which it enables the power supply of said household appliance, characterized in that it comprises a blocking lever (13) arranged so as to assume a first position, in which with its own dimensions it prevents said locking pin (16) to move from said retracted position to said extracted position, and a second position, in which it releases said locking pin (16), so as to allow the movement from said retracted position to said extracted position, and in that said slider (15) and said blocking lever (13) are configured so that the movement of said slider (15) from said rest position to said working position causes the movement from said first position to said second position of said blocking lever (13).

The present invention also relates to a household appliance.

### RELATED APPLICATIONS

This application claims the benefit of priority of Italian Patent Application No. 102020000001417 filed on Jan. 24, 2020, the contents of which are incorporated herein by reference in their entirety.

### FIELD AND BACKGROUND OF THE INVENTION

The present invention relates to a door-lock device for household appliances, in particular washing machines for laundry and the like, and household appliances comprising this device.

More in detail, the invention relates to a door-lock device of the above type, which makes easier the reopening of the door in case of overloading of the drum, for example, due to very bulky and not wet clothes, which exert a push on the door.

In the following, the description will address the use of the door-lock in a washing machine, but it is clear that it should not be considered limited to this specific use.

As is well known, there are currently door-lock devices for washing machines configured to prevent the door from opening until the end of the washing cycle of the household appliance.

These door-lock devices generally comprise a containment casing, coupled to the frame of the washing machine, having an opening, through which the prong associated with the washing machine door is inserted, a rotating hook, intended to intercept the prong when the door is closed, a slider, having an opening and movable with respect to the containment casing between a rest position, in which it is held by a return or thrust spring, which it assumes when the prong is disengaged from the rotating hook, and between a working position, caused by the rotation of said rotating hook, when the latter engages with the prong.

Furthermore, the door-lock devices according to the prior art also comprise an electromechanical control module, which comprises a locking pin that can be activated by the control logic of said household appliance, capable of assuming a retracted position, when the washing machine is not active, in which it is retained by the encumbrance of the slider when the latter is in the rest position; and an extracted position, which it can assume when the washing machine is active and the slider is in said working position, such that said pin can be inserted into said opening.

When the locking pin is extracted, the control logic is capable of establishing that the door is closed and locked.

A drawback of these door-lock devices lies in the fact that, in case of very bulky laundry, that is not wet, within the drum, once the door is closed, the reopening of the door before starting the washing cycle, for the possible loading of further laundry is extremely difficult, due to the door being blocked.

This block is caused by the thrust that the non-wet laundry exerts on the door from the inside of the drum and by the consequent stresses generated on the slider and therefore on the locking pin. In particular, if the stress of the cloths exceeds a certain threshold, the friction between the lateral surface of the slider for opening, and the pin can cause the latter to block, such that the electromechanical control device may not be able to return the pin from the extracted position to the retracted position, if necessary. In this case, it would be impossible to open the door to complete the additional load and the consequent blocking of the household appliance.

It is clear that this type of door-lock device is inconvenient if the user needs to load further laundry into the washing machine after having carried out a first load and closed the door.

### SUMMARY OF THE INVENTION

In the light of the above, it is therefore an object of the present invention to guarantee the user that the door can be reopened following a first load of laundry, and a first closure of the door.

A further object of the invention is therefore avoiding excessive stress on the locking pin, in case of clothes in the drum, which exert considerable stress on the door.

Another object of the invention is that of guaranteeing the resistance of the locking pin in case of reopening of the door.

It is therefore specific object of the present invention a door-lock device for a household appliance, such as a washing machine and the like, wherein said household appliance comprises a door provided with a prong, comprising a containment casing, a holding unit, arranged in said containment casing, intended to engage with the prong for holding it, a slider, contained in a containment casing, associated with said holding unit, so as to assume a rest position and a working position, when said prong is engaged with said holding unit, an electromechanical control module comprising a locking pin, capable of assuming a retracted position, in which it disables the power supply of said household appliance, and an extracted position, in which it enables the power supply of said household appliance, characterized in that it comprises a blocking lever arranged so as to assume a first position, in which with its own dimensions it prevents said locking pin to move from said retracted position to said extracted position, and a second position, in which it releases said locking pin, so as to allow the movement from said retracted position to said extracted position, and in that said slider and said blocking lever are configured so that the movement of said slider from said rest position to said working position causes the movement from said first position to said second position of said blocking lever.

Always according to the invention, said blocking lever may be pivoted on a pin so as to rotate with respect to said pin.

Still according to the invention, said pin may be fixed to said containment casing.

Advantageously according to the invention, said slider may comprise a curve guide and said blocking lever may comprise a cam arranged so as to slide on said curve guide, wherein, when said slider moves from said rest position to a working position, said blocking lever moves from said first to said second position, and vice versa.

Preferably according to the invention, said holding unit may comprise a hook, intended to engage with said prong of said door, a shaft, arranged so as to rotate when said prong is engaged with said rotating hook, wherein said shaft comprises a relief, arranged so as to cause the movement from said rest position to said working position of said slider when said prong is engaged with said rotating hook.

Further according to the invention, said shaft may be pivoted on said containment casing.

Always according to the invention, said containment casing may have an opening, through which said prong can be inserted, and said hook may be arranged in correspondence of said opening, so as to engage with said prong when said door of said household appliance is closed.

It is further object of the present invention a household appliance, such as a washing machine and the like, comprising a chassis, having a compartment accessible through an opening, a door, hinged to said chassis for closing said opening for access to a basket or the like, a prong associated to said door, and characterized in that it comprises a lock-door system as defined above.

### BRIEF DESCRIPTION OF THE SEVERAL VIEWS OF THE DRAWINGS

The present invention will be now described, for illustrative but not limitative purposes, according to its preferred embodiments, with particular reference to the figures of the enclosed drawings, wherein:

FIG. 1 illustrates a partial plan view of the door-lock device according to the invention in an open condition of the washing machine door;

FIG. 2 illustrates a partial section of the door-lock device according to the invention, as in FIG. 1, along the plane A-A;

FIG. 3 illustrates a partial plan view of the door-lock device according to the invention in a closed condition of the washing machine door;

FIG. 4 illustrates a partial section of the door-lock device according to the invention, as in FIG. 3, along the plane B-B;

FIG. 5 illustrates a partial plan view of the door-lock device according to the invention in a closed condition of the washing machine door during an attempt to open it; and

FIG. 6 illustrates a partial section of the door-lock device according to the invention as in FIG. 5 along the plane C-C.

### DESCRIPTION OF SPECIFIC EMBODIMENTS OF THE INVENTION

In the various figures, similar parts will be indicated by the same reference numbers.

With reference to FIGS. 1-6, a door-lock device 1 according to the present invention can be seen, essentially comprising a containment casing 11, a holding unit 12, intended to engage with a prong 14, which the washing machine door is equipped with (not shown in the figures), a slider 15, a blocking lever 13, associated with the slider 15, and an electromechanical control module for controlling the power supply of the household appliance.

The containment casing 11, visible only partially in the indicated figures, is equipped with an opening 112, into which the prong 14 is inserted when the door of the washing machine is closed.

The holding unit 12 comprises a hook 121, a shaft 122, hinged on both ends to the containment casing 11, so as to be able to rotate with respect to it, and a relief 123, obtained on said shaft 122, whose operation will be better defined and described below.

Said holding unit 12 is arranged in correspondence with said opening 112, so that when said prong 14 enters in the opening 112, it interferes with the hook 121, causing its roto-translation, thanks to the rotation of shaft 122 and retains said prong 14. In other words, said hook 121 and said shaft 122 interact in such a way that, when the prong 14 engages with said hook 121, such that said hook rotates and possibly partially moves with respect to the disengagement position, said shaft 122 is rotated by a predefined angle, so as to also move the position of the relative relief 123. In some embodiments said hook 121 and said shaft 122 can be made in one piece.

The slider 15 interacts with the shaft 122 through said relief 123 so that when the shaft 122 rotates by the aforementioned angle, the slider 15 translates passing from a rest position to a working position, in which it is engaged with said relief 123 of the shaft 122.

Said slider 15 is held in its rest position by a thrust spring not shown in the figures. Therefore, when said slider 15 is translated by said relief 123 following the rotation of said shaft 122, it contrasts with the action of the thrust spring.

The slider 15 also has a curved guide 151 on its upper surface, the operation of which will be better defined below.

The electromechanical control module, arranged below said slider 15, comprises a locking pin 16, configured so as to assume a retracted position, in which it prevents the washing machine or the household appliance in general from being powered when the washing machine door is open, and an extracted position, in which it allows the washing machine or household appliance to be power supplied, which it can assume when the washing machine door is closed.

The blocking lever 13 is able to rotate with respect to a pin 131 fixed on the containment casing 11 and is equipped with a cam 132, capable of cooperating with said curved guide 151 of the slider 15.

The rotation of the blocking lever 13 with respect to the pin 131 allows the blocking lever 13 itself to assume a first position and a second position.

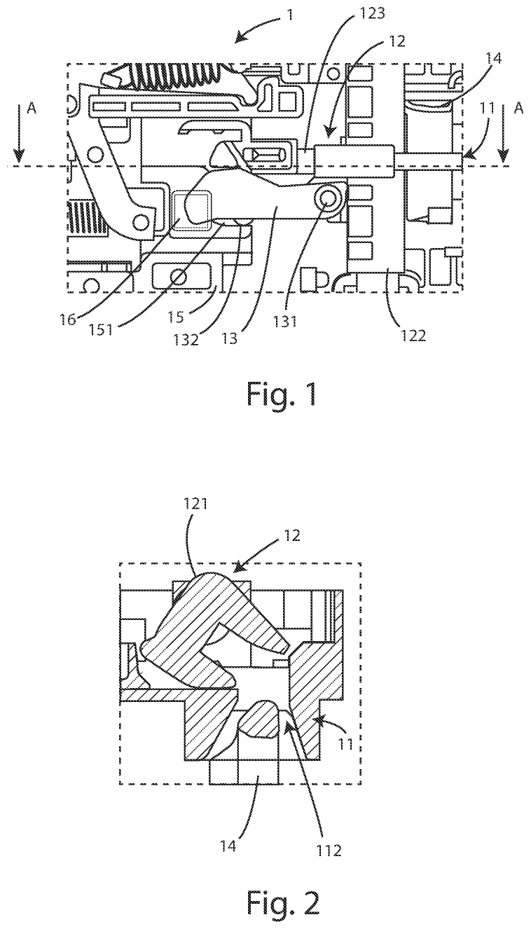

In the first position, shown in FIGS. 1-2, taken when the slider 15 is in the rest position, the blocking lever 13 with its own overall dimensions ensures that the locking pin 16 remains in its retracted position, with the washing machine door open.

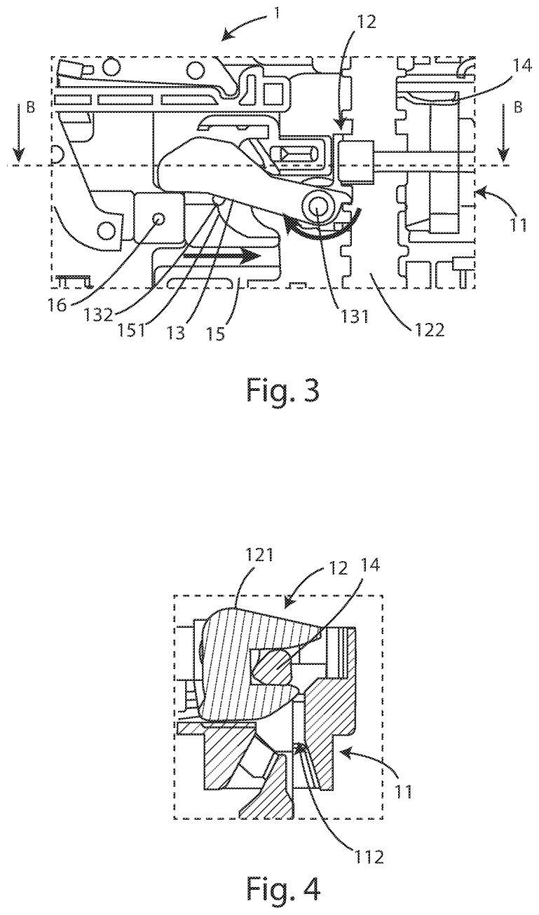

The second position of the locking pin 16, shown in FIGS. 3-4, is assumed when the slider 15 translates to the working position, when the door is closed, due to the engagement of the hook 121 with the prong 14 and the consequent rotation of the shaft 122 and of the relief 123, the cam 131 consequently slides on the curved guide 151 of the slider 15, causing the rotation of the blocking lever 13 freeing the locking pin 16.

The operation of the door-lock device 1 described above is as follows.

When the door of the washing machine is open (see FIGS. 1 and 2), so as to allow the user, for example, to load the clothes inside the drum, the prong 14 is not inserted in the opening 112 of the containment casing 11 and does not interfere with the hook 121 of the retaining member 12, which is therefore disengaged.

In this condition, the slider 15 is held in its rest position by the thrust spring (as said, not shown in the figures), and the blocking lever 13 is in the retracted position, in which, with its bulk, it prevents the locking pin 16 from sticking out.

In particular, in the present embodiment, said lever is superimposed on said locking pin 16, precisely preventing it from moving to said working position even following activation by the control logic unit by means of said electromechanical control module, for example in case of failure.

Since the locking pin 16 is held in its retracted position by the blocking lever 13, the electromechanical control module prevents the washing machine from being powered at this stage, naturally in conditions of correct operation.

When the user has finished loading the clothes into the drum, the washing machine door is closed (see FIGS. 3 and 4), the prong 14 is inserted into the opening 112, so as to engage with the hook 121. The hook 121 is shaped in such a way that, when it comes into contact with the prong 14, it is subjected to a rotation and a translation as described above, such as to cause the rotation of the shaft 122.

In this configuration, the relief 123 of the shaft 122 interacts with said slider 15, causing it to translate and causing it to pass from the rest position to the working position.

Simultaneously with the translation of the slider 15, the blocking lever 13 rotates clockwise, as shown in FIG. 3, around the pin 131, due to the fact that the cam 132 slides along with the curved guide 151 of the slider 15. In this way, the blocking lever 13 passes from said first to said second position, in which it releases the locking pin 16, which is free.

Since the locking pin 16 is free, thanks to the rotation of the blocking lever 13, the electromechanical control module allows, following an electronic command by the logic control unit of the household appliance to which it is connected, to pass said locking pin 13 from said first position to said second position, possibly allowing the power supplying of the washing machine, or of the household appliance in general, and therefore the activation of the working program (for example the washing program).

In said second position, said locking pin 13 does not allow the slider 15 to return from said working position to said rest position. In this way, the slider 15 does not in turn allow said shaft 122 to rotate, and therefore said hook 121 to disengage from said prong 14. Therefore, when said locking pin 13 is in said second position, the door is not only closed, as it is engaged with the hook, but it is also locked. In other words, in such a way to achieve the effect that the user cannot open the door while the household appliance carries out a program, for example when a washing machine carries out a washing program.

If the washing machine drum was excessively loaded, such that during the washing operations the washing machine door was subjected to excessive stress from the inside, the entire mechanical system would in turn be subjected to certain stress.

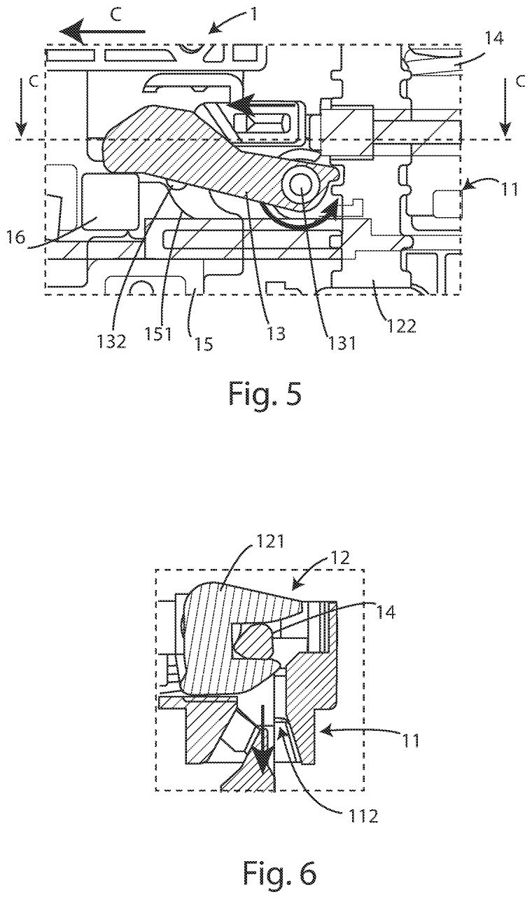

In particular, in this situation, (see FIGS. 5 and 6) the relief 123 would push the slider 15 to the left (arrow C), as shown in FIG. 5. At the same time, the slider 15, pushed by the relief 123 would cause a stress on the blocking lever 13, on the side surface of the locking pin 16.

However, with the same stress of the door, by means of the configuration at issue, on the locking pin 16, there is a stress by the blocking lever 13 (in particular on the lateral surface of said locking pin 16) much less than in the prior art.

Therefore, if the user wishes to open the door, by acting on a suitable command to interrupt the washing program in progress, the locking pin 16 could pass from said extracted position to said retracted position.

Therefore, as can be seen, the geometry has such a configuration that by exploiting the lever principles, an advantageous reduction of the forces applied on the locking pin 16 is obtained, to a point of application of a force and equilibrium of the moments.

Therefore, in this condition, the locking pin 16 is not subjected to stresses such as to be blocked, and the electromechanical control module commands the locking pin 16 to pass from its extracted position to its retracted position, thus allowing the opening of the door for loading additional laundry.

An advantage of the door-lock device according to the present invention is that of guaranteeing the reopening of the door of the household appliance after a first load, even in the presence of bulky clothes that push the door.

A further advantage of the door-lock device according to the present invention is that of reducing the stresses on the locking pin, in case of the presence in the drum of clothes which exert considerable stress on the door.

Another advantage of the door-lock device according to the present invention is that of guaranteeing the correct functioning of the locking pin in case of reopening of the door.

The present invention has been described for illustrative but not limitative purposes, according to its preferred embodiments, but it is to be understood that modifications and/or changes can be introduced by those skilled in the art without departing from the relevant scope as defined in the enclosed claims.

What is claimed is:

1. Door-lock device (1) for a household appliance, such as a washing machine and the like, wherein said household appliance comprises a door provided with a prong (14), comprising
a containment casing (10),
a holding unit (12), arranged in said containment casing (10), intended to engage with the prong (14) for holding it,
a slider (15), contained in a containment casing (10), associated with said holding unit (12), so as to assume a rest position and a working position, when said prong (14) is engaged with said holding unit (12),
an electromechanical control module comprising a locking pin (16), capable of assuming a retracted position, in which it disables the power supply of said household appliance, and an extracted position, in which it enables the power supply of said household appliance,
characterized
in that it comprises a blocking lever (13) arranged so as to assume
a first position, in which with its own dimensions it prevents said locking pin (16) to move from said retracted position to said extracted position, and
a second position, in which it releases said locking pin (16), so as to allow the movement from said retracted position to said extracted position, and
in that said slider (15) and said blocking lever (13) are configured so that the movement of said slider (15) from said rest position to said working position causes the movement from said first position to said second position of said blocking lever (13).

2. Door-lock device (1) according to claim 1, characterized in that said blocking lever (13) is pivoted on a pin (131) so as to rotate with respect to said pin (131).

3. Door-lock device (1) according to claim 2, characterized in that said pin (131) is fixed to said containment casing (11).

4. Door-lock device (1) according to claim 1, characterized
in that said slider (15) comprises a curve guide (151) and
in that said blocking lever (13) comprises a cam (132) arranged so as to slide on said curve guide (151),
wherein, when said slider (15) moves from said rest position to a working position, said blocking lever (13) moves from said first to said second position, and vice versa.

5. Door-lock device (1) according to claim 1, characterized in that said holding unit (12) comprises
a hook (121), intended to engage with said prong (14) of said door,
a shaft (122), arranged so as to rotate when said prong (14) is engaged with said rotating hook (121), wherein said shaft (122) comprises a relief (123), arranged so as to cause the movement from said rest position to said working position of said slider (15) when said prong (14) is engaged with said rotating hook (121).

6. Door-lock device (1) according to claim 5, characterized in that said shaft (122) is pivoted on said containment casing (11).

7. Door-lock device (1) according to claim 5, characterized
in that said containment casing (11) has an opening (112), through which said prong can be inserted (14), and
in that said hook (121) is arranged in correspondence of said opening (112), so as to engage with said prong (14) when said door of said household appliance is closed.

8. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 1.

9. Door-lock device (1) according to claim 2, characterized
in that said slider (15) comprises a curve guide (151) and
in that said blocking lever (13) comprises a cam (132) arranged so as to slide on said curve guide (151),
wherein, when said slider (15) moves from said rest position to a working position, said blocking lever (13) moves from said first to said second position, and vice versa.

10. Door-lock device (1) according to claim 3, characterized
in that said slider (15) comprises a curve guide (151) and
in that said blocking lever (13) comprises a cam (132) arranged so as to slide on said curve guide (151),
wherein, when said slider (15) moves from said rest position to a working position, said blocking lever (13) moves from said first to said second position, and vice versa.

11. Door-lock device (1) according to claim 2, characterized in that said holding unit (12) comprises
a hook (121), intended to engage with said prong (14) of said door,
a shaft (122), arranged so as to rotate when said prong (14) is engaged with said rotating hook (121), wherein said shaft (122) comprises a relief (123), arranged so as to cause the movement from said rest position to said working position of said slider (15) when said prong (14) is engaged with said rotating hook (121).

12. Door-lock device (1) according to claim 3, characterized in that said holding unit (12) comprises
a hook (121), intended to engage with said prong (14) of said door,
a shaft (122), arranged so as to rotate when said prong (14) is engaged with said rotating hook (121), wherein said shaft (122) comprises a relief (123), arranged so as to cause the movement from said rest position to said working position of said slider (15) when said prong (14) is engaged with said rotating hook (121).

13. Door-lock device (1) according to claim 4, characterized in that said holding unit (12) comprises
a hook (121), intended to engage with said prong (14) of said door,
a shaft (122), arranged so as to rotate when said prong (14) is engaged with said rotating hook (121), wherein said shaft (122) comprises a relief (123), arranged so as to cause the movement from said rest position to said working position of said slider (15) when said prong (14) is engaged with said rotating hook (121).

14. Door-lock device (1) according to claim 6, characterized
in that said containment casing (11) has an opening (112), through which said prong can be inserted (14), and
in that said hook (121) is arranged in correspondence of said opening (112), so as to engage with said prong (14) when said door of said household appliance is closed.

15. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 2.

16. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 3.

17. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 4.

18. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 5.

19. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 6.

20. Household appliance, such as a washing machine and the like, comprising
a chassis, having a compartment accessible through an opening,
a door, hinged to said chassis for closing said opening for access to a basket or the like,
a prong (14) associated to said door, and
characterized in that it comprises a lock-door system (1) according to claim 7.
